(19) United States
(12) Patent Application Publication
(10) Pub. No.: US 2022/0164468 A1
(43) Pub. Date: May 26, 2022

(54) METHODS AND SYSTEMS FOR ENTITLEMENT SERVICE DESIGN AND DEPLOYMENT

(71) Applicant: Caterpillar Inc., Peoria, IL (US)

(72) Inventors: Sushil Kumar Gupta, Dunlap, IL (US); Manjunath P. Krishnaiah, Frisco, TX (US); Pradeep Maddineni, Chicago, IL (US); Tejas H. Shah, Dunlap, IL (US); Joshua Z. Sprague, Chicago, IL (US); Matthew Steffen, Chicago, IL (US); Phani Sai Krishana Thaduvayi, Peoria, IL (US)

(21) Appl. No.: 17/529,116

(22) Filed: Nov. 17, 2021

Related U.S. Application Data
(60) Provisional application No. 63/117,358, filed on Nov. 23, 2020.

(51) Int. Cl. G06F 21/62; G06F 21/33

(52) U.S. Cl. CPC G06F 21/6227; G06F 2221/2141; G06F 21/33

(57) ABSTRACT

A technique is directed for managing entitlements within a real-time telemetry system. In an embodiment, access to entitlements is organized between an entitlement management service and an entitlement retrieval service. The entitlement management service may permit users to manage users and roles. The entitlement retrieval service may retrieve logged-in user's entitlements on a restricted basis using the information in an authorization token. The system may maintain separation between the entitlement management application programming interface (API) and entitlement retrieval API within the entitlement service, such that separation between entitlement management APIs, entitlement retrieval APIs, and entitlement enforcements may be enforced.

### BACKGROUND

A user may request data by logging into a database with access credentials. Depending on the user credentials, the user may have restricted access to the database. Currently, when accessing a database, the user can only represent a single organization and is limited to a single role when accessing data related to the request.

### SUMMARY

In some embodiments, a method for provisioning and managing entitlements for a user-restricted query to access data within a derived dataset, includes updating, by an entitlement management application programing interface (API), a user role database, a role policies database, and a policies database. The method can include retrieving, by an entitlement retrieval API, user entitlements for authorizing application access and data entitlement API access. The method can further include enforcing, by the data entitlement API, the user entitlements retrieved by a user entitlement retrieval API based on information in an authentication token, generating an entitlement filter based on the entitlement retrieval API, sending, to a data API, the entitlement filter, wherein the data API provides querying with the entitlement filter to derived datasets with entitlement contracts, receiving, from the derived dataset, results, wherein the results are determined based on parameters in the entitlement filter, enforcing the user entitlements to the derived datasets based on commands from the entitlement management API, receiving a request containing the authentication token, accessing a derived dataset schema catalog to interpret the entitlement filter, retrieving the user entitlements based on information in the authentication token, and separating entitlement user tables and entitlement role tables within the entitlement management API, wherein the entitlement management API and the entitlement retrieval API are separated within an entitlement service to enforce the user entitlements.

In some embodiments, a system for provisioning and managing entitlements for a user-restricted query to access data within a derived dataset, includes updating, by an entitlement management application programing interface (API), a user role database, a role policies database, and a policies database. The system can include retrieving, by an entitlement retrieval API, user entitlements for authorizing application access and data entitlement API access. The system can further include enforcing, by the data entitlement API, the user entitlements retrieved by a user entitlement retrieval API based on information in an authentication token, generating an entitlement filter based on the entitlement retrieval API, sending, to a data API, the entitlement filter, wherein the data API provides querying with the entitlement filter to derived datasets with entitlement contracts, receiving, from the derived dataset, results, wherein the results are determined based on parameters in the entitlement filter, enforcing the user entitlements to the derived datasets based on commands from the entitlement management API, receiving a request containing the authentication token, accessing a derived dataset schema catalog to interpret the entitlement filter, retrieving the user entitlements based on information in the authentication token, and separating entitlement user tables and entitlement role tables within the entitlement management API, wherein the entitlement management API and the entitlement retrieval API are separated within an entitlement service to enforce the user entitlements.

In some embodiments, the system can further include one or more processors; and one or more memory devices having stored thereon instructions that when executed by the one or more processors cause the one or more processors to perform at least one of the following: (i) update, by an entitlement management application programing interface (API), a user role database, a role policies database, and a policies database; (ii) retrieve, by an entitlement retrieval API, user entitlements for authorizing application access and data entitlement API access; (iii) enforce, by the data entitlement API, the user entitlements retrieved by a user entitlement retrieval API based on information in an authentication token; (iv) generate an entitlement filter based on the entitlement retrieval API; (v) send, to a data API, the entitlement filter, wherein the data API provides querying with the entitlement filter to derived datasets with entitlement contracts; (vi) receive, from the derived dataset, results, wherein the results are determined based on parameters in the entitlement filter; (vii) enforce the user entitlements to the derived datasets based on commands from the entitlement management API; (viii) receive a request containing the authentication token; (ix) accessing a derived dataset schema catalog to interpret the entitlement filter; (x) retrieve the user entitlements based on information in the authentication token; (xi) and separating entitlement user tables and entitlement role tables within the entitlement management API, wherein the entitlement management API and the entitlement retrieval API are separated within an entitlement service to enforce the user entitlements.

Other aspects will appear hereinafter. The features described herein can be used separately or together, or in various combinations of one or more of them.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for an entitlement service.

FIG. 5 is a conceptual diagram illustrating an example of an entitlement modular or scalable design.

FIG. 6 is a conceptual diagram illustrating an example of an entitlement service dataflow.

FIG. 7 is a conceptual diagram illustrating an example of an entitlement service development.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems of managing entitlements within a real-time telemetry system. An entitlement service is needed in a platform to determine what the end-users, using/accessing the platform, either through applications (built on the platform) or through other platform/services, can access. In some cases, this access is primarily focused on the data in the platform, or the access is used for application features. In an embodiment, access to entitlements are organized between an entitlement management service and an entitlement retrieval service. The entitlement management service may permit, by the administrator, users to retrieve/manage other users and roles. The entitlement retrieval service may retrieve logged-in user entitlements on a restricted (e.g., read-only) basis using the information in an authorization token. The system may maintain separation between the entitlement management application programming interface (API) and entitlement retrieval API within the Entitlement (Core) Service, such that separation/decoupling between entitlement management APIs, entitlement retrieval APIs, and entitlement enforcements may be enforced by use of a Policy Management Points (PMP), Policy Decision Points (PDP), and Policy Enforcement Points (PEP), respectively, within a policy/attribute-based access control system.

In some implementations, data models contain internal entitlement tables. In some cases, separating entitlement user tables and entitlement role tables (e.g., in the normalized form) provides flexibility and reusability, while not impacting the performance of the entitlement service based on the use-cases and query patterns. Tables can be added for policies/permissions to provide flexibility and reusability. Entitlement user tables and entitlement role tables may provide flexibility and reusability advantages.

Various embodiments may provide one or more of the following technological improvements: 1) normalization between the tables provides the benefits of reusability, modularity, while creating the balance with the performance; 2) attributes are tagged at any level in any table providing a hybrid-model between Role-Based Access Control (RBAC) and Role-Based Access Control (ABAC); 3) roles are platform-level or application specific to meet the business needs where the same user coming in from different applications can have different roles/permissions for the same data; 4) roles are reused for multiple organizations/regions/modules within the same application (or platform for the platform-level roles); 5) a user at the same time represents multiple organizations/regions with independent multiple roles within the same application or platform; 6) a user has multiple roles within the same organization/region/module within an application or platform; 7) the entitlements for a user are combined using union of all the entitlements while maintaining the application and organizational/regional boundaries; 8) a user has different roles (independently) in each entitlement (e.g., organization or region) the user is representing; 9) the organizations are divided into further smaller sections using attributes (e.g., geographic regions) and/or hierarchal structures (e.g., division/departments); 10) the roles are at the platform level and application specific; 11) the roles are module specific within the application; and 12) a user is assigned different roles across entitlements. If a user has roles that have conflicting access to a data domain, the user can receive access to all or individual data domains. The access may provide the union of the permission by each data-domain and action, while maintaining organization, region boundaries, and granularity.

In some implementations, separation between entitlement core services (e.g., policy management and policy decision) and entitlement enforcement (policy enforcement) provides the benefits of using the same entitlement core services (technology agnostic) for enforcement on multiple types of data APIs and storage (e.g., database) technologies. In some cases, the service registry and data schema catalog serve as a bridge between enforcement on multiple types of data APIs and storage technologies.

In some implementations, separation between entitlement/policy management and entitlement retrieval (policy decision) services provides a layer of security, while the management services use the entitlement retrieval service to make decisions regarding the management of users, roles, permissions, and policies. In some cases, separation between authentication and authorization provides multiple/different types of authentication mechanisms, including the federation with a corporate directory or social-networking sites.

In some implementations, the JavaScript Object Notation (JSON) structures are designed for providing data. In some cases, application entitlements are flexible, modular, or scalable. In other cases, the application entitlements provide granular control to the precise tables, and column and row level filters using the data-domains, actions, and the allowed fields and filter conditions. Filter conditions can incorporate multiple attributes with multiple values, and can be combined with “AND” and/or “OR” operations to create any unique combination.

In some implementations, JSON structures are designed to represent role permissions (e.g., data permissions and app permissions). JSON structures can create user permissions. JSON structures can be used to store permissions/policies in the roles table and the policies table (e.g., for performance for entitlements providing granular control).

In some implementations, JSON structures store, maintain, and provide details about data a user is entitled to and actions the user can perform on this data. The data can be divided into data-domains for granular control. A data-domain can have a set of tables holding data where permissions apply, or the data-domain can have an individual table. The actions can be any action required for business processes, in addition to the API actions (e.g., create, read, update, or delete operations), or HTTP verbs (e.g., GET, POST, PUT, DELETE, etc.), or database operations (e.g., insert, update, delete, mark favorite/private, search, list, dispatch, etc.). In some cases, roles/users have different entitlements/permissions/policies even though the roles or users are performing the same operations on the databases using the same HTTP verb and/or API actions/endpoints. In some implementations, the permissions are technology agnostic or translated to enforce on different technologies.

In some implementations, within a data-domain and action pair, granular control (e.g., based on the row and column level filters) is put on for each role independently (e.g., for each data-domain and action pair separately) using a column/attribute value (e.g., separate policies for read, create, update, and delete for the asset core data for each role independently, and additionally for the telemetry data, workorder data, and user data). In some cases, the granular control and scalability are multiple levels.

In some implementations, the JSON structure stores, maintains, and provides details about the features/screens a user can access within the application (U/I). The JSON structures can provide three levels of granularity by dividing applications into modules, modules into pages, and pages into components/buttons/features. A user may have access, partial access, or no access to the applications.

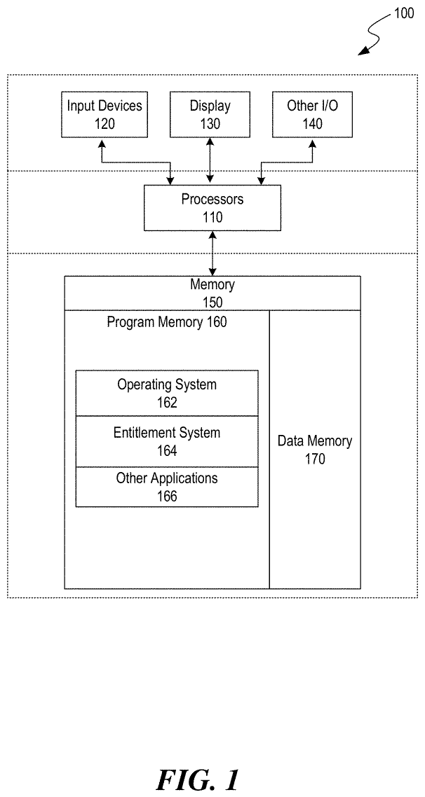

Several implementations are discussed below in more detail in reference to the figures. FIG. 1 is a block diagram illustrating an overview of devices on which some implementations of the disclosed technology can operate. The devices can comprise hardware components of a device 100 that manage entitlements within a real-time telemetry system. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, entitlement system 164, and other application programs 166. Memory 150 can also include data memory 170, entitlement data, user data, retrieval data, management data, authorization token data, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

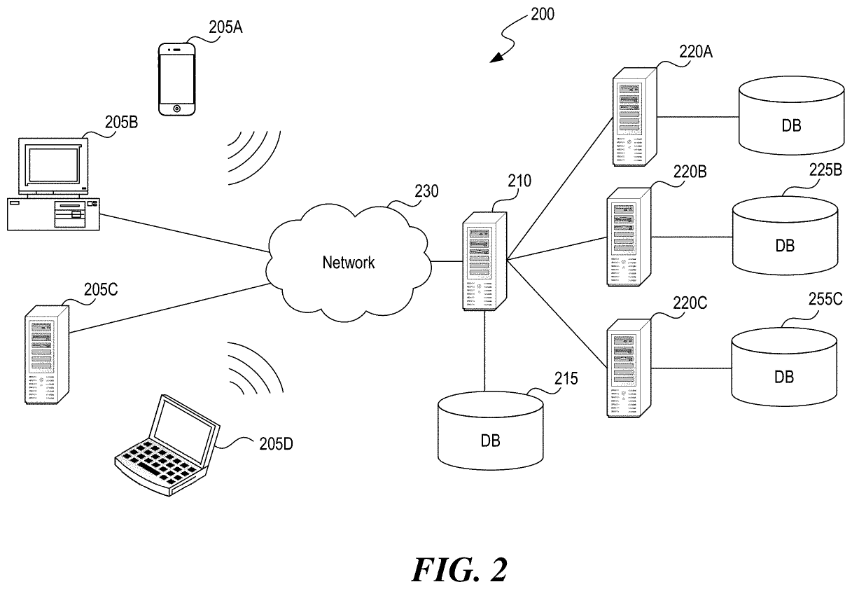

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as entitlement data, user data, retrieval data, management data, authorization token data, configuration data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

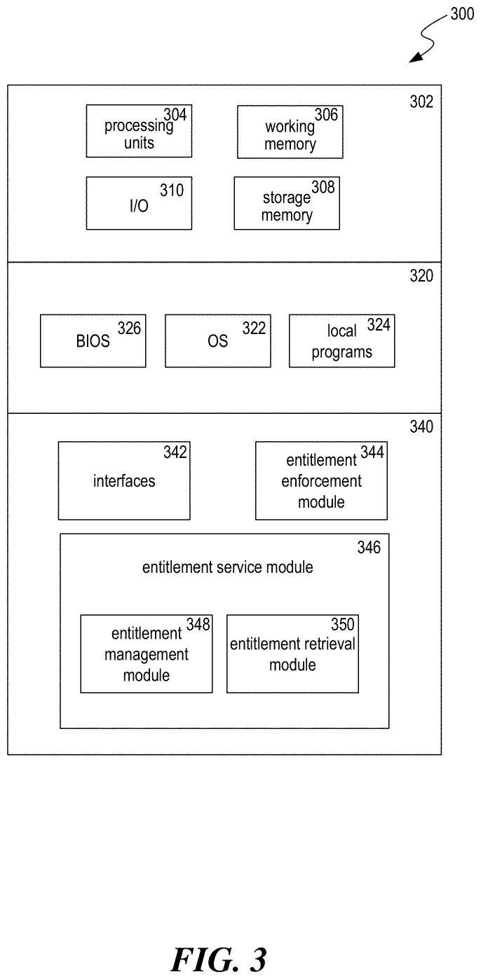

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include entitlement enforcement module 344, entitlement service module 346, entitlement management module 348, entitlement retrieval module 350, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

In some embodiments, the entitlement enforcement module 344 is configured to maintain separation between the management and retrieval APIs within the entitlement (core) service (e.g., separation/decoupling between entitlement management APIs, retrieval APIs, and entitlement enforcements). In some embodiments, the entitlement service module 346 is configured to enforce separation between the management and retrieval APIs within the entitlement (core) service, such that separation/decoupling between entitlement management APIs, retrieval APIs, and entitlement enforcements is enforced by use of a Policy Management Points (PMP), Policy Decision Points (PDP), and Policy Enforcement Points (PEP), respectively, within a policy/attribute-based access control system. In some embodiments, the entitlement management module 348 is configured to permit the administrator users to retrieve/manage other users and roles. In some embodiments, the entitlement retrieval module 350 is configured to retrieve logged-in user's entitlements on a read-only basis using the information in authorization token. In some cases, the entitlement service module 346 includes the entitlement management module 348 and the entitlement retrieval module 350. Enforcement can include comparing values, permissions, entitlements, rights to access, rights to user, or authentication credentials users attempting to access the information.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

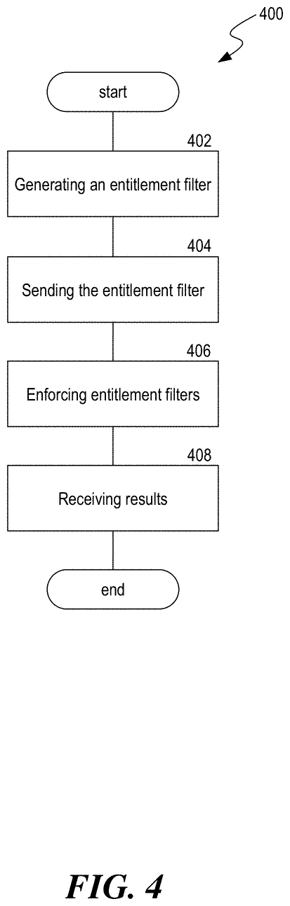

FIG. 4 is a flow diagram illustrating a process 400 used in some implementations for an entitlement service. The entitlement service system can update by an entitlement management API, a user role database, a role policies database, and a policies database. An entailment retrieval API can retrieve user entitlements for authorizing application access and data entitlement API access. At step 402, the entitlement service system may generate an entitlement filter based on the entitlement management API and/or the entitlement retrieval API. At step 404, the entitlement service system may send the entitlement filter to a data API, wherein the data API provides querying with the entitlement filter to derived datasets with entitlement contracts. At step 406, the data entitlement API enforces the user entitlements retrieved by the user entitlement retrieval API based on information in an authentication token. Enforcing user entitlement can include comparing values, permissions, entitlements, rights to access, rights of a user, or verifying authentication credentials of users attempting to access the information. Enforcing the user entitlements can provide control over the rights to the entitlement service. By enforcing the user entitlements, the entitlement service system can grant, resolve, or revoke access to entitlements. At step 408, the data API service system may receive results from the derived dataset, wherein the results are determined based on parameters in the enforcement filter.

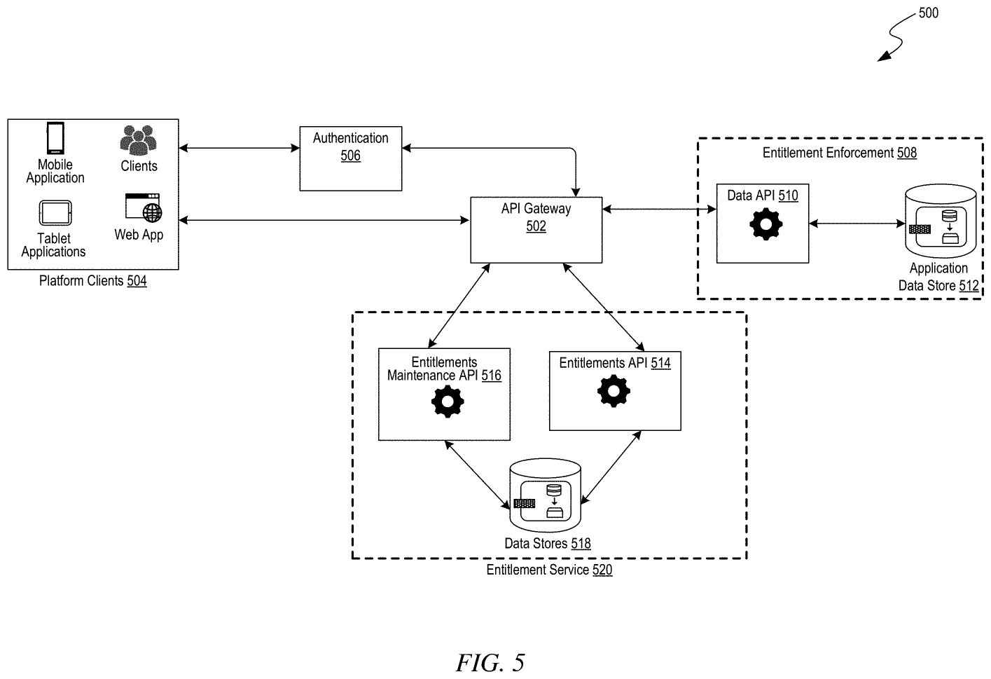

FIG. 5 is a conceptual diagram illustrating an example 500 of a modular and scalable architecture/design. Separation (or decoupling) between the authentication service and the entitlement service may allow for any token-based authentication service (e.g., OAuth) to be used (e.g., federated social-networking, messaging, and email services) for enforcing user entitlements. In some cases, the separation is integrated with API management services (e.g., an Apigee™ management service and/or AWS™ API Gateways/Load-balancers). In some implementations, separation (or decoupling) between entitlement (core) service and entitlement enforcement allows the entitlement (core) service to be used with different types of APIs/services (e.g., using database/storage technologies).

For example, a platform clients module 504 (e.g., mobile application, clients, tablet applications, web application, etc.) can request a token from authentication module 506. Authentication module 506 can request and receive a validated token from API gateway 502. The platform clients module 504 can receive the token from the authentication module 506 and make a request to the API gateway 502 with the token. API gateway 502 can route the request to the appropriate API in the entitlement enforcement module 508. The data API 510 can retrieve data based on filters from the application data store 512. The data API 510 can send a response to the API gateway 502. API gateway 502 can cache the response. API gateway 502 can request entitlements from the entitlements API 514. The entitlements API 514 can retrieve entitlements based on rules and policies from the data stores 518. The API gateway 502 can communicate with the entitlements maintenance API 516 to maintain entitlements. The entitlements maintenance API 516 and the data stores 518 can read/update rules and policies. In some implementations, the entitlements maintenance API 516 and entitlements API 514 are part of the entitlement service 520. The entitlements maintenance API 516 can filter criteria for the request and send the filtered criteria response to the API gateway 502. The API gateway 502 can return the response to the client at the platform clients 504.

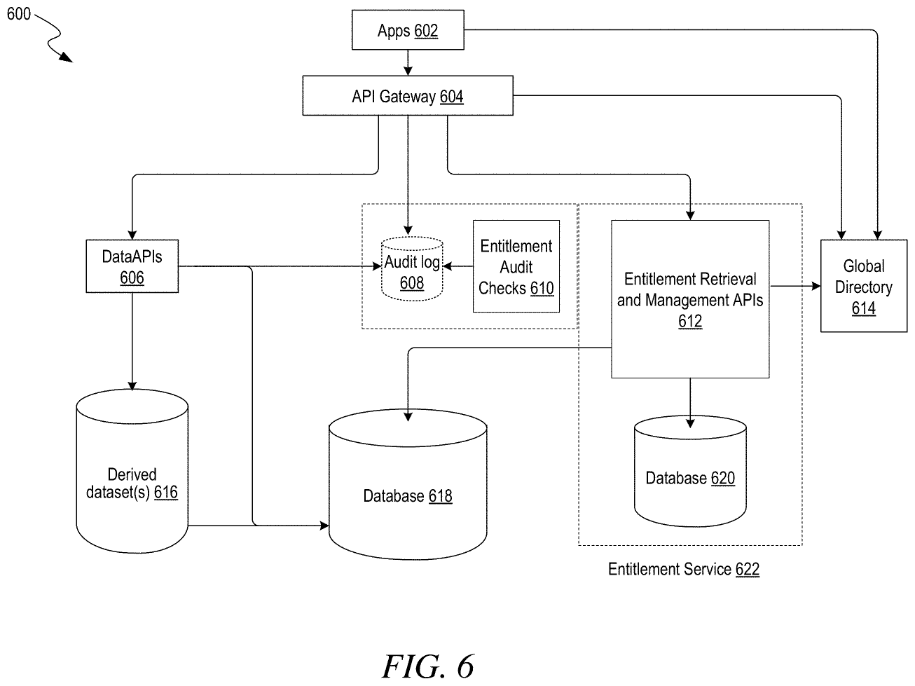

FIG. 6 is a conceptual diagram illustrating an example 600 of an entitlement service dataflow. In some implementations, example 600 can illustrate integration points with the other components of a server platform (e.g., Helios™ platform), or a corporate directory service. In some cases, the entitlement service 622 may leverage the service registry and dataset schema catalog to provide expandability and scalability while minimizing the changes in the entitlement service code (e.g., when a new dataset and/or data API/service is added to the platform). Applications 602 can connect to API gateway 604. Applications 602 and API gateway 604 can access a global directory 614. API gateway 604 can transmit a token to the entitlement service 622. The entitlement service 622 can include entitlement retrieval and management APIs 612 (e.g., connected to database 618 and/or database 620 with policy information, role information, service registry, and/or derived dataset(s)).

In some implementations, the entitlement service 622 sends entitlement filters to the API gateway 604 to provide querying with the entitlement filters. The API gateway 604 can send the entitlement filters to the data APIs 606, which retrieves results from derived datasets 616. The data APIs 606 can use a derived dataset(s) schema catalog to interpret entitlement filters.

The entitlement service 622 may derive datasets with entitlement contracts based on the querying with the entitlement filters. The entitlement filters may determine the operation and data access (e.g., read only, administrative privileges, etc.) the user can perform. For example, if the user is logged in with read-only permissions on a derived dataset, the entitlement filter determines the user can access, but not update or delete the data.

In some implementations, the entitlement audit checks 610 verifies changes made to derived datasets and enforces the entitlement filter. The entitlement audit checks 610 may process (e.g., in real-time) and record all transaction data. For example, the entitlement audit checks 610 verifies the audit log 608 when troubleshooting or when querying data based on an entitlement filter.

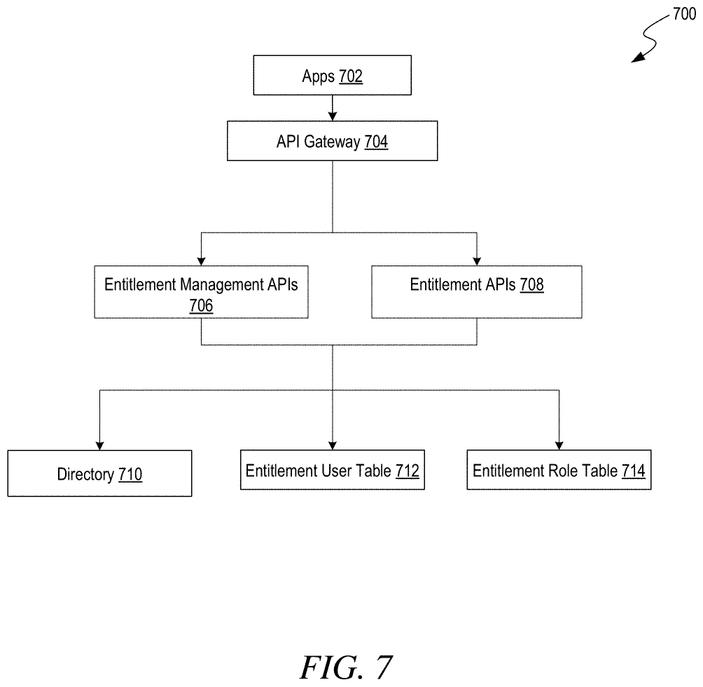

FIG. 7 is a conceptual diagram illustrating an example 700 of an entitlement service deployment. In some implementations, administrators use the entitlement management APIs 706 to retrieve/manage/create/update other users and roles. Applications 702 can connect to API gateway 704. API gateway 704 can connect to entitlement management APIs 706 and entitlement APIs 708. The entitlement management APIs 706 can enforce logged-in admin's data entitlements for users via the entitlement APIs 708 (e.g., authorization, account selection, etc.). The entitlement management APIs 706 can access a directory 710, an entitlement user table 712, and an entitlement role table 714 for data.

In some implementations, the entitlement APIs 708 retrieves logged-in user entitlements using the information in a token. In some cases, data APIs and applications use the entitlement APIs to enforce the logged-in user's entitlements. In other cases, the entitlement APIs 708 are read only APIs. The entitlement system may maintain separation between the management API and entitlement API within the entitlement (core) service, such that separation/decoupling between entitlement management APIs, retrieval APIs, and entitlement enforcements may be enforced by use of a Policy Management Points (PMP), Policy Decision Points (PDP), and Policy Enforcement Points (PEP), respectively, within a policy/attribute-based access control system (e.g., in the industry).

In some implementations, the management APIs use the retrieval APIs to access the entitlements of the administrator user to enforce management. In some cases, management APIs use and enforce the entitlements. In some implementations, there are data models for internal entitlement tables. In some cases, separate tables for entitlement users and entitlement roles (e.g., in the normalized form) provide flexibility and reusability. Separate tables for entitlement users (e.g., who can update user entitlements) and entitlement roles (e.g., system level updating of who can update entitlement roles) may not impact the performance of the entitlement service based on the use-cases and query patterns.

Entitlement user table 712 and entitlement role table 714 may provide flexibility and reusability advantages. A user can represent multiple organizations. A user can have multiple roles in the same organization. A user can have different roles (independently) in each organization it is representing. The organizations can be divided into further smaller sections using attributes (e.g., geographic regions) and/or hierarchal structures (e.g., division/departments). The roles can be at the platform level, as well as, application specific. The roles can also be module specific within the application, or roles can be reused across multiple organizations/applications.

In some implementations, the entitlement role table 714 maintains details (e.g., capabilities/permissions) about each role. In some cases, records for each role are created/updated with permissions based on the capabilities required. The entitlement service may categorize application roles into multiple sub-categories based on the modules in an application. Categorizing roles into multiple sub-categories may result in additional tagging (or attributes) for the roles and may entail an additional column in the entitlement role table 714 for storing the module name (e.g., as a sub-category within an application). In some cases, the module name is added to the sort key to increase search performance. In other cases, the module name is used as an additional filter condition after searching using the sort key. In some implementations, the administrator accesses (e.g., see/assign/modify) all or some of the roles belonging the administrator's modules.

In some implementations, the entitlement user table 712 maintains a record for each user for each organization or region that the user is entitled to. In some cases, multiple records are added for a user, if the user is entitled to multiple organizations/regions. The role identification column in the entitlement user table 712 can store multiple roles per record so the user is assigned multiple roles for the region/organization. In some cases, the module user administrator see/assign roles only belonging to their module, to maintain separate entitlement records for the users for each module they have at least one role in. The entitlement service can add a column for storing module name in the entitlement user table 712. In some cases, the module name is added to the sort key for search performance. In other cases, the module name is used as a filter condition after searching using the sort key because each module user admin is allowed to see/assign/modify roles belonging to their modules only for a user. An administrator can see/assign/modify all the roles for a user. A module admin may administrate for multiple modules (e.g., process multiple records for each module). In some cases, the admin role is given to a user and the roles belonging to the module and respective records are removed (e.g., no other module admin can modify modify/add any more roles for the user).

In some implementations, the JavaScript Object Notation (JSON) structures are designed for providing data. In some cases, application entitlements are flexible and scalable. In other cases, the application entitlements provide granular control. Structures can be used to store permissions/policies in the roles table and the policies table (e.g., for performance for large/complex entitlements providing granular control).

In some implementations, JSON structures may store, maintain, and provide details about data a user is entitled to and actions the user can perform on this data. In some cases, the JSON structure determines the entitlement filter for the data. The data can be divided into data-domains for granular control. A data-domain can have a set of tables holding data where permissions apply, or the data-domain can have an individual table. The actions can be any action required for processes, in addition to the API actions (e.g., CRUD), or HTTP verbs (e.g., GET, POST, PUT, DELETE etc.), or database operations (e.g., insert, update, delete, mark favorite/private, search, list, dispatch etc.). In some cases, roles or users have different entitlements/permissions/policies even though the roles or users may be performing the same operations on the databases using the same HTTP verb and/or API actions/endpoints. In some implementations, the user management endpoints retrieve/modify the records (with module name filter) for which the logged in user has entitlements for (e.g., for module admins, it will be records with a module name filter and will replace the roles for that record). For the GET operations, the user management endpoints may retrieve the records with a module name matching the entitlements and combine them for each party in the output. Table 1 illustrates the user management endpoints.

TABLE 1

| Endpoint | Using Role [symbol] D? | Already an Array? | Impact Analysis |
|---|---|---|---|
| Get /invites(invited) | No | | No impact |
| Get /invites | Yes | Yes | Store and handle multiple role [symbol] ds for each invites |
| | | | invite data model/table already has role [symbol] d as an array |
| | | | Swagger also has it as array, just need to remove the max limit |
| POST /invites | Yes | Yes | Store and handle multiple role [symbol] ds for each invite |
| | | | invite data model/table already has role [symbol] d as an array |
| | | | Swagger also has it as array, just need to remove the max limit |
| GET /users | Yes | Yes | Store and handle multiple role [symbol] ds for each user record |
| | | | Entitlement User data model/table already has role [symbol] d as an array |
| | | | Swagger also has it as array, just need to remove the max limit |
| GET /users/(catrecid) | Yes | Yes | Store and handle multiple role [symbol] ds for each user record |
| | | | Entitlement user data model/table already has role [symbol] d as an array |
| | | | Swagger also has it as array, just need to remove the max limit |
| GET /user/search | Yes | Yes | Store and handle multiple role [symbol] ds for each user record |
| | | | Entitlement User data model/table already has role [symbol] d as an array |
| | | | Swagger also has it as array, just need to remove the max limit |
| PATCH /user/(catrecid) | Yes | Yes | Store and handle multiple role [symbol] ds for each user record |
| | | | Entitlement User data model/table already has role [symbol] d as an array |
| | | | Swagger also has it as array, just need to remove the max limit |

[symbol]

indicates data missing or illegible when filed

In some implementations, within a data-domain and action pair, granular control (e.g., based on the row and column level filters) is put on for each role independently (e.g., for each data-domain and action pair separately) using any column/attribute value (e.g., separate policies for read, create, update, and delete for the asset core data for each role independently, and additionally for the telemetry data, workorder data, and user data). In some cases, the granular control and scalability is multiple levels.

In some implementations, the JSON structure stores, maintains, and provides details about the features/screens a user can access within the application (U/I). The JSON structures can provide three levels of granularity by dividing applications into modules, modules into pages, and pages into components/buttons/features. A user can have access or no access to the applications. In some implementations, the segregation of entitlement management APIs and entitlement retrieval APIs is virtualized and/or represented in hardware. Entitlement service and entitlement enforcement can be separated within implementations.

### INDUSTRIAL APPLICABILITY

The systems and methods described herein can manage an entitlement service for users accessing data. Access to entitlements can be organized between an entitlement management service and entitlement retrieval service. The entitlement management service may permit users to manage other users and roles. The entitlement retrieval service may retrieve logged-in user's entitlements. The entitlement system may maintain separation between the management APIs and retrieval APIs within the entitlement (core) service, such that decoupling between entitlement management APIs, retrieval APIs, and entitlement enforcements is enforced. The present systems and methods can be implemented to manage, control, and communicate multiple industrial machines, vehicles and/or other suitable devices such as mining machines, trucks, corporate fleets, etc.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for provisioning and managing entitlements for a user-restricted query to access data within a derived dataset, the method comprising:
updating, by an entitlement management application programing interface (API), a user role database, a role policies database, and a policies database;
retrieving, by an entitlement retrieval API, user entitlements for authorizing application access and data entitlement API access;
enforcing, by the data entitlement API, the user entitlements retrieved by a user entitlement retrieval API based on information in an authentication token;
generating an entitlement filter based on the entitlement retrieval API;
sending, to a data API, the entitlement filter, wherein the data API provides querying with the entitlement filter to derived datasets with entitlement contracts; and
receiving, from the derived dataset, results, wherein the results are determined based on parameters in the entitlement filter.

2. The method of claim 1, further comprising:
enforcing the user entitlements to the derived datasets based on commands from the entitlement management API.

3. The method of claim 1, further comprising:
receiving a request containing the authentication token.

4. The method of claim 1, further comprising:
accessing a derived dataset schema catalog to interpret the entitlement filter.

5. The method of claim 1, further comprising:
retrieving the user entitlements based on information in the authentication token.

6. The method of claim 1, further comprising:
separating entitlement user tables and entitlement role tables within the entitlement management API.

7. The method of claim 1, wherein the entitlement management API and the entitlement retrieval API are separated within an entitlement service to enforce the user entitlements.

8. A computing system comprising:
at least one processor; and
at least one memory storing instructions that, when executed by the processor, cause the computing system to perform a process for provisioning and managing entitlements for a user-restricted query to access data within a derived dataset, the process comprising:
updating, by an entitlement management application programing interface (API), a user role database, a role policies database, and a policies database;
retrieving, by an entitlement retrieval API, user entitlements for authorizing application access and data entitlement API access;
enforcing, by the data entitlement API, the user entitlements retrieved by a user entitlement retrieval API based on information in an authentication token;
generating an entitlement filter based on the entitlement retrieval API;
sending, to a data API, the entitlement filter, wherein the data API provides querying with the entitlement filter to derived datasets with entitlement contracts; and
receiving, from the derived dataset, results, wherein the results are determined based on parameters in the entitlement filter.

9. The computing system of claim 8, wherein the process further comprises:
enforcing the user entitlements to the derived datasets based on commands from the entitlement management API.

10. The computing system of claim 8, wherein the process further comprises:
receiving a request containing the authentication token.

11. The computing system of claim 8, wherein the process further comprises:
accessing a derived dataset schema catalog to interpret the entitlement filter.

12. The computing system of claim 8, wherein the process further comprises:
retrieving the user entitlements based on information in the authentication token.

13. The computing system of claim 8, wherein the process further comprises:
separating entitlement user tables and entitlement role tables within the entitlement management API.

14. The computing system of claim 8, wherein the entitlement management API and the entitlement retrieval API are separated within an entitlement service to enforce the user entitlements.

15. A non-transitory computer-readable medium storing instructions that, when executed by a computing system, cause the computing system to perform operations for provisioning and managing entitlements for a user-restricted query to access data within a derived dataset, the operations comprising:
updating, by an entitlement management application programing interface (API), a user role database, a role policies database, and a policies database;
retrieving, by an entitlement retrieval API, user entitlements for authorizing application access and data entitlement API access;
enforcing, by the data entitlement API, the user entitlements retrieved by a user entitlement retrieval API based on information in an authentication token;
generating an entitlement filter based on the entitlement retrieval API;
sending, to a data API, the entitlement filter, wherein the data API provides querying with the entitlement filter to derived datasets with entitlement contracts; and
receiving, from the derived dataset, results, wherein the results are determined based on parameters in the entitlement filter.

16. The non-transitory computer-readable medium of claim 15, wherein the operations further comprise:
enforcing the user entitlements to the derived datasets based on commands from the entitlement management API.

17. The non-transitory computer-readable medium of claim 15, wherein the operations further comprise:
receiving a request containing the authentication token.

18. The non-transitory computer-readable medium of claim 15, wherein the operations further comprise:
accessing a derived dataset schema catalog to interpret the entitlement filter.

19. The non-transitory computer-readable medium of claim 15, wherein the operations further comprise:
retrieving the user entitlements based on information in the authentication token.

20. The non-transitory computer-readable medium of claim 15, wherein the entitlement management API and the entitlement retrieval API are separated within an entitlement service to enforce the user entitlements.
